(19) United States
(12) Patent Application Publication
(10) Pub. No.: US 2026/0350405 A1
(43) Pub. Date: Nov. 5, 2026

(54) Unified Valuation Framework (UVF) for Adaptive Decision Optimization in Autonomous and Distributed Systems

(71) Applicant: Johan Oscar Hallgren, Songdo (KR)

(72) Inventor: Johan Oscar Hallgren, Songdo (KR)

(21) Appl. No.: 19/194,512

(22) Filed: Apr. 30, 2025

(51) Int. Cl. G06N 3/092; G06F 17/11

(52) U.S. Cl. CPC G06N 3/092; G06F 17/11

(57) ABSTRACT

The Unified Valuation Framework (UVF) provides a modular optimization structure enabling autonomous agents and distributed systems to dynamically optimize cumulative operational value by balancing opportunity capture, future potential, environmental coordination, operational costs, and continuity risks. The framework employs a tunable, multi-dimensional valuation function that adaptively reweights decision criteria in real time, supporting optimization across dynamic, adversarial, stochastic, and cooperative environments. A formal optimization theorem demonstrates that UVF agents statistically outperform purely greedy agents under specified adversarial conditions. Unlike reinforcement learning (RL) or Markov Decision Process (MDP) models, UVF does not require episodic training, value iteration, or policy convergence, and instead enables context-sensitive action selection using localized environmental feedback. This supports adaptive optimization in safety-critical, adversarial, or resource-constrained domains, including but not limited to military autonomy, financial trading, disaster response, cloud resource management, resilient transportation, AI planning under uncertainty, and autonomous space exploration.

### TECHNICAL FIELD

The present invention relates to decision optimization systems and methods for autonomous agents and distributed systems operating in dynamic, stochastic, cooperative, and adversarial environments. More specifically, it relates to a modular, adaptive, valuation-driven optimization framework for optimizing cumulative operational value, applicable across various domains including artificial intelligence (AI), robotics, finance, logistics, infrastructure management, disaster response, and autonomous space exploration.

### BACKGROUND

Traditional autonomous systems and distributed decision-making architectures often rely on static or greedy heuristics that optimize for immediate local rewards. While often effective in simple or static environments, such methods may degrade under dynamic and adverse conditions, including shifting resource landscapes, adversarial interference, and decentralized coordination challenges.

Although more sophisticated autonomous and distributed decision frameworks have emerged, many still face limitations in adaptively balancing short-term operational objectives with long-term strategic positioning—especially under dynamically evolving, stochastic, or adversarial conditions.

Furthermore, existing optimization systems often rely on periodic retraining, manual tuning or reconfiguration, or batch updates to maintain effectiveness as environmental conditions shift. Such dependence on external intervention limits true autonomy and impairs operational continuity in highly dynamic or uncertain environments.

Existing frameworks often fail to adequately address the challenge of simultaneously balancing immediate reward capture, future opportunity expansion, continuity risk mitigation, environmental coordination, and operational costs within dynamic and evolving operational contexts.

Accordingly, there is a need for a generalizable decision framework that enables autonomous agents and distributed systems to sustainably optimize cumulative operational value through continuous real-time adaptation across complex, dynamic, stochastic, cooperative, and adversarial environments.

### Note on Relationship to Broader Theory:

The Unified Valuation Framework (UVF) disclosed herein is part of a broader theoretical construct referred to as the Hallgren Unified Valuation Theory (HUVT).

HUVT seeks to generalize valuation-driven decision-making and optimization across centralized and decentralized computational, social, political, economic, biological, and strategic systems, including, but not limited to, these domains.

The broader theoretical construct underlying UVF may be elaborated separately in future academic or commercial publications, but is not necessary for the implementation or understanding of the present invention.

### SUMMARY OF THE INVENTION

The Unified Valuation Framework (UVF) disclosed herein provides a modular and adaptive optimization architecture that enables autonomous agents and distributed systems to make context-sensitive decisions in complex, dynamic environments. Unlike conventional decision models that rely on static heuristics or fixed reward functions, UVF introduces a tunable, multi-dimensional valuation function that continuously balances competing priorities such as short-term reward, long-term opportunity, coordination potential, operational cost, and survivability.

Each agent independently computes a valuation score for available actions by combining weighted components representing immediate benefit, future potential, coordination, environmental richness, and associated costs. The valuation function V(a) for a candidate action a is defined as:

V(a)=αB·B(a)+αO·O(a)+αS·S(a)+αE·E(a)−αC·C(a)−αOC·OC(a)

### Where:

B(a): Immediate reward opportunity (e.g., direct benefit or gain)
O(a): Option expansion (future opportunities enabled by the action)
S(a): Strategic synergy or environmental coordination (alignment with other agents or structures)
E(a): Environmental richness (resource abundance or reward density)
C(a): Operational or resource cost, including execution effort and internal risk factors such as system fragility or potential failure
OC(a): Opportunity cost, including the estimated value of foregone alternatives and survivability risks

The weighting coefficients αB, αO, αS, αE, αC, and αOC are dynamically tunable and may be adapted in real time based on environmental conditions, agent state, mission parameters, or policy updates. At each decision cycle, the agent or system selects the action a* that maximizes the valuation function:

a*=arg max{V(a)|a∈A}

Where A represents the current set of feasible actions at that decision point.

UVF supports deployment across centralized, semi-centralized, and fully decentralized architectures. In decentralized settings, agents may exhibit emergent coordination by acting on locally perceived valuation signals—such as relative agent proximity encoded in the S(a) term—rather than through explicit signaling or global planning. The architecture is modular, comprising physically or logically distinct components for sensing, valuation, decision execution, and adaptive parameter adjustment.

This structure enables scalable, real-time optimization across decentralized, semi-centralized, or centralized systems without requiring explicit retraining, rigid programming, or fixed reward rules. By dynamically balancing short-term gain, long-term potential, operational cost, and strategic positioning, UVF provides a generalizable foundation for intelligent decision-making across a wide range of operational contexts.

Unlike reinforcement learning (RL) and traditional Markov Decision Process (MDP) frameworks, which rely on episodic reward accumulation, fixed state transition models, and convergence toward optimal long-term policies via iterative training, the Unified Valuation Framework (UVF) operates in real time using dynamically reweighted valuation components without requiring value iteration, policy convergence, or global state estimation. UVF agents compute action preferences by evaluating a modular valuation function composed of tunable components that reflect immediate benefit, future potential, coordination synergy, environmental richness, operational cost, and survivability-weighted opportunity cost. These components are continuously updated based on local feedback, enabling context-sensitive decision-making under bounded decision-time constraints. The architecture does not require offline training episodes, reward shaping, or policy gradient estimation, thereby avoiding typical limitations of RL in rapidly changing, safety-critical, or adversarial environments. This differentiates UVF from both model-free and model-based RL systems and enables it to support dynamic optimization in domains where retraining or static policies are infeasible.

### DETAILED DESCRIPTION OF THE INVENTION

The following description elaborates the modular architecture, operational mechanisms, and strategic behaviors enabled by the Unified Valuation Framework (UVF).

### 1. Agent Architecture

Each agent operating under UVF comprises the following modular subsystems:

### Sensing Module

Detects immediate environmental features, including rewards, penalties, and the positions and behaviors of other agents.

### Valuation Module

Computes the valuation function V(a) for each candidate action based on sensor input and current valuation parameter settings.

### Decision Module

Selects and executes the optimal action a* that maximizes V(a) across the available action set, where:

a*=arg max{V(a)|a in A}
and A represents the available actions at that decision point.
If multiple candidate action yield the same maximal valuation, the system applies a predefined tie-breaking policy, which may be explicitly configurable and deterministic if required for critical applications. For real-time or resource-constrained environments, the module implement approximate maximization methods, such as heuristic pruning or early-exit evaluation strategies, to reduce computational overhead. In multi-agent contexts, the Decision Module may additionally incorporate coordination or negotiation protocols to align decisions across agents or subsystems.

### Adaptation Module

Dynamically adjusts the valuation weights (alpha parameters) based on environmental feedback, strategic shifts, mission parameters, or internal policy updates.

These modules may be physically distinct components or logically integrated within a single system.

In some embodiments, each agent may include a sensing module, a valuation module, a decision module, and an adaptation module locally. In other embodiments, one or more of these modules may be centrally implemented, shared across multiple agents, or dynamically reallocated between agents and centralized systems. Module location and integration may vary depending on computational resources, communication capabilities, environmental conditions, or mission requirements.

This modular flexibility allows UVF deployments to optimize for performance, resilience, and operational efficiency across diverse architectural configurations, including fully decentralized, semi-centralized, and centralized systems.

### 2. Dynamic Updating and Learning

Agents continuously update their valuations in real time in response to changes in:
Available opportunities,
Environmental threats,
Group or swarm behavior,
Internal resource status.

Dynamic updating ensures agents remain responsive and do not rely on static heuristics or rigid programming, enabling adaptation across dynamic, stochastic, cooperative, and adversarial environments.

Parameter tuning can be implemented through:
Rule-based heuristics,
Reinforcement learning algorithms,
Evolutionary strategies,
Mission-specific programmed policies.

### Adaptive Reweighting—Illustrative Example

In some embodiments, the dynamic reweighting of valuation parameters may be governed by rule-based policies, environmental feedback mechanisms, or other adaptive strategies. For example, if an agent's cumulative penalty exposure increases by more than 20% over a five-decision-cycle moving window, the system may dynamically increase the weighting parameter associated with opportunity cost (αOC) by 0.3 and simultaneously reduce the weighting on immediate reward opportunity (αB) by 0.2. This reweighting allows the agent to shift strategic focus from short-term reward acquisition to survivability optimization in response to elevated environmental threats.

Adaptive reweighting may be driven by techniques including, but not limited to, heuristic thresholds, moving averages, exponential decay windows, biologically inspired feedback mechanisms, meta-learning systems, or mission-specific tuning strategies. Notably, such reweighting can occur without requiring episodic retraining, global state convergence, or policy stabilization, further distinguishing the Unified Valuation Framework (UVF) from conventional reinforcement learning or Markov Decision Process approaches.

In some embodiments, the agent adjusts its valuation weights based on recent environmental feedback using a rule-based heuristic. For instance, the system may track cumulative penalties and rewards over a rolling window of several decision steps. If the cumulative penalty exposure during this period exceeds a predefined threshold (for example, 20 percent of the maximum allowable penalty), the agent increases the weighting on the opportunity cost component (αOC) to emphasize survivability and risk aversion. Simultaneously, it may decrease the weighting on immediate reward (αB) to reduce exposure to high-risk decisions driven purely by short-term gains.

Conversely, if the cumulative reward collected over the same window falls below an expected threshold (such as 50 percent of a baseline reward performance level), the agent increases the weights on forward-looking opportunity (αO) and environmental richness (αE), encouraging exploration or repositioning toward higher-value regions.

After these updates, the weights may be normalized to maintain a consistent total influence, ensuring that the relative contributions of each component remain proportionally balanced. This allows the valuation function to remain responsive while avoiding runaway dominance of any single factor. The updated weights are then applied in the next decision cycle, enabling continuous real-time adaptation without requiring retraining or external recalibration.

### 3. Architectural Flexibility

The UVF architecture supports multiple deployment configurations:

### Decentralized Swarming

Agents operate independently without centralized control, coordinating emergently through local valuation-driven behavior.

### Semi-Centralized Architectures

Selected agents may assume leadership or aggregation roles while maintaining localized autonomy.

### Centralized Control Systems

A centralized authority dynamically assigns or updates valuation parameters across the agent network.

This modular flexibility allows UVF-based systems to adapt based on mission complexity, computational resource availability, communication constraints, and strategic requirements.

### 4. Operational Lifetime and Agent Termination Conditions

UVF-optimized agents aim to maximize cumulative operational value across their operational lifetime, balancing short-term gain and long-term survivability.

Agents face operational termination under adverse conditions:

### Operational Termination Rule:

An agent is operationally terminated if:
   Its cumulative penalty score exceeds a predefined survival threshold (T); or
   It directly encounters a lethal environmental hazard.

### Impact of Operational Termination:

Upon termination, the agent is removed from further decision-making cycles. Its cumulative valuation potential collapses to zero.

### Survival-Aware Behavior:

UVF agents actively manage survivability as an internal optimization objective, balancing reward capture against operational risk over time.

This survival-aware strategy allows UVF-driven systems to maintain strategic coherence, maximize mission success rates, and sustain higher cumulative net operational value under adverse conditions.

In some scenarios, it is beneficial to include an intermediate fallback policy to prevent agents from prematurely reaching termination conditions due to extreme valuation collapse or adversarial disruptions.

### 5. Fallback Policy on Degenerate Valuation Conditions

In some embodiments, if the computed valuation scores V(a) for all available actions fall below a predefined minimum threshold (Vmin), or if the dynamic weighting parameters (a parameters) degrade to levels that render reliable decision-making infeasible, the agent activates a fallback action policy. The fallback policy may include, but is not limited to:
Entering a safe idle state (e.g., hover mode, standby mode),
Retreating to a predefined safe zone,
Executing a low-risk, minimal-penalty action, or
Requesting external assistance or escalating decision control to an external authority.

This fallback mechanism ensures that agents maintain operational safety and continuity even under conditions of valuation collapse, sensor failure, or adversarial environmental degradation.

The fallback activation threshold (Vmin) and the specific fallback actions may be configured based on mission parameters, operational context, or agent policy settings.

### Illustrative Example—Autonomous Swarm Simulation in a Dynamic Grid Environment

### Overview

A simulated operational environment is constructed as a two-dimensional 50×50 grid representing a contested operational zone. Ten autonomous aerial agents (drones) operate within this environment under dynamic conditions designed to test multi-dimensional decision strategies.

The environment includes:
Reward Targets—positive-value locations (e.g., surveillance nodes, energy beacons)
Penalty Zones—hazardous regions simulating environmental risk, interference, or hostile threats

Agents make movement decisions using a Unified Valuation Function (UVF):

V(a)=αB·B(a)+αO·O(a)+αS·S(a)+αE·E(a)−αC·C(a)−αOC·OC(a)

Where:
B(a)—Immediate reward availability
O(a)—Future opportunity access
S(a)—Spatial synergy or dispersion with nearby agents
E(a)—Environmental richness (reward density and accessibility)
C(a)—Operational cost (e.g., distance, time, or energy)
OC(a)—Opportunity cost, including survivability risk or foregone safer paths

All weighting coefficients (αB through αOC) are dynamically tunable based on mission context, agent status, or environmental feedback.

### Simulation Configuration

Grid Size: 50×50
Agents: 10 UVF-driven agents, 10 Greedy baseline agents
Reward Targets: 10 (removed upon capture by nearest agent)
Penalty Zones: 30 (static, with radius-based penalties)
Decision Horizon: 20 steps
Runs: 10 independently seeded trials
Termination Threshold: T=10, with an additional −5 death penalty

### Scoring and Termination Logic

### Reward Scoring:

+10 when entering proximity (≤1 grid unit) of a reward target (target is removed; only one agent may claim per step)

### Penalty Scoring:

−5 per cycle within 1 unit of a penalty zone
−3 per cycle within 2 units

### Termination:

Agents are removed from the simulation once cumulative penalties exceed T=10. No further scoring occurs after operational termination.

### UVF Parameter Configuration (Example)

αB=4.0, αO=2.5, αS=1.5, αE=2.0, αC=1.0, αOC=3.0

This configuration emphasizes risk mitigation, multi-step value potential, and coordinated dispersion over short-term gain.

Observed Results (Mean±Std over 10 Runs)

| | UVF Agents | Greedy Agents | | |
|---|---|---|---|---|
| Metric | (mean ± std) | (mean ± std) | t-stat | p-value |
| Gross Rewards | 4.8 ± 6.6 | 3.2 ± 5.7 | — | — |
| Gross Penalties | −0.2 ± 0.9 | −4.9 ± 4.1 | — | — |
| Net Operational | 4.6 ± 6.4 | −1.7 ± 7.3 | 6.55 | 0.0000 |
| Value | | | | |
| Survival Rate | 100.0% across | 68.0% ± 46.9% | 6.83 | 0.0000 |
| | tested seeds | | | |

All values represent agent-level means over 10 randomized runs.

### INTERPRETATION

In the evaluated simulation runs, UVF agents achieved higher survival rates and net operational value compared to Greedy agents. This performance advantage reflects UVF's ability to integrate immediate rewards, forward-looking opportunity, and risk-aware decision-making through its multi-dimensional valuation function. Greedy agents, restricted to optimizing short-term reward (B(a)) without regard for exposure or future loss, were more likely to encounter penalty-heavy zones and experience early termination.

These illustrative results support UVF's capacity to outperform purely greedy heuristics by adaptively balancing multiple valuation criteria in dynamic environments. Comparative evaluation against other static or rule-based strategies is outside the scope of this example.

1. A decision optimization framework for autonomous or distributed systems, comprising:
(a) a sensing subsystem, implemented in software, firmware, or hardware, configured to detect environmental features including reward targets, penalty zones, and proximity to task-relevant entities, without requiring centralized state estimation or global coordination;
(b) a valuation subsystem, implemented as software or dedicated circuitry, configured to compute a real-time valuation score for each candidate action using the following weighted function:
V(a)=αB×B(a)+aO×O(a)+αS×S(a)+αEx E(a)−αCxC(a)−αOC×OC(a)
where:
B(a) represents the immediate utility of the task based on detected reward, time constraints, or domain-specific objectives;
O(a) represents future opportunity for expansion based on forward planning horizons;
S(a) represents the coordination value determined by agent relationships or dependencies;
E(a) represents environmental richness;
C(a) represents operational costs;
OC(a) represents opportunity cost;
(c) a decision subsystem, implemented via executable logic, configured to select an optimal action a* from a feasible set A, such that:
a*=arg max V(a), for all a in A;
(d) an adaptation subsystem, configured to continuously adjust one or more a coefficients based on environmental feedback, agent status, or mission-specific parameters;
wherein the framework operates without the need for global state estimation, centralized coordination, episodic training, or convergence of policies.

2. The framework of claim 1, wherein the adaptation component adjusts the weighting coefficients by applying rule-based thresholds, such that the coefficient for opportunity cost (αOC) is increased when the agent's cumulative penalty score increases by more than a defined percentage over a moving decision window, and the coefficient for immediate reward (αB) is decreased accordingly.

3. The framework of claim 1, wherein agent behavior is configured to maximize operational lifetime by balancing short-term reward capture against cumulative penalty exposure, and the weighting parameters are dynamically adjusted in response to proximity to environmental threats or survivability thresholds.

4. The framework of claim 1, wherein the system architecture supports decentralized, semi-centralized, or fully centralized topologies, and agents operate either independently or in coordination using locally computed valuation signals.

5. The framework of claim 1, wherein the valuation function is configurable such that, under degenerate weighting configurations where αB is greater than zero and all other weighting parameters are zero, the framework replicates greedy reward maximization behavior, and under multi-dimensional weighting configurations, supports strategic tradeoff optimization across multiple objectives.

6. The framework of claim 1, wherein the agent is excluded from further decision cycles upon exceeding a predefined survivability threshold or entering a terminal environmental hazard zone.

7. The framework of claim 1, wherein the decision-making agents operate in a financial trading system and the valuation function comprises:
B(a): expected execution profit or realized spread;
O(a): flexibility for rebalancing or hedge path continuation;
S(a): coordination with other trading agents or strategies;
E(a): market richness including depth, volatility, or arbitrage opportunities;
C(a): execution cost including slippage or fees;
OC(a): opportunity cost from missed latency windows, adverse exposure, or market drift.

8. The framework of claim 1, wherein the decision-making agents represent delivery units operating in a logistical network, and the valuation function comprises:
B(a): utility of successful delivery or task completion;
O(a): preservation of future routing or delivery chain flexibility;
S(a): coordination with nearby agents to minimize congestion;
E(a): proximity to depots, charging stations, or high-density demand zones;
C(a): fuel usage, mechanical wear, or time delay;
OC(a): opportunity cost from failed delivery or rerouting penalties.

9. The framework of claim 1, wherein the weighting parameters are preconfigured using values determined through simulation, expert-defined policy, or prior benchmarking, and remain fixed throughout runtime operation without adaptive updating.

10. The framework of claim 1, wherein the agent is implemented as a physical autonomous system comprising a sensor array, onboard processing unit, and actuator control mechanism, and wherein decisions are made without pre-scripted rule sets or centralized replanning.

11. The framework of claim 1, wherein the valuation function operates under bounded decision-time constraints without requiring policy convergence, episodic training, or long-term optimization, and the adaptation logic enables real-time reweighting of valuation components in response to dynamic environmental feedback.

12. The framework of claim 1, wherein, if all computed valuation scores fall below a predefined threshold or if the α parameters degrade to levels that prevent reliable decision-making, the agent activates a fallback policy comprising at least one of:
(a) entering a safe idle or standby mode;
(b) retreating to a predefined safe location;
(c) executing a low-risk, low-penalty action; or
(d) escalating control to an external supervisory authority.

13. A method for allocating computational tasks across a distributed cloud system, comprising:
detecting task demands, resource availability, and inter-agent contention in real time;
for each candidate task allocation action, computing a valuation score based on:
(a) execution utility of the task;
(b) preservation of future resource flexibility;
(c) load balancing coordination with other compute nodes;
(d) proximity to data or network optimization zones;
(e) operational cost in terms of power, time, or hardware load; and
(f) opportunity cost due to degraded service-level objectives or missed task deadlines;
selecting the task allocation with the highest valuation score; and
dynamically adjusting weighting coefficients based on system load, task priority, and service-level feedback;
wherein task assignment is performed without centralized scheduling, fixed rules, or policy convergence requirements.

14. A method for adaptive control of a decision-making agent in a dynamic environment, comprising:
detecting environmental inputs including task opportunities, hazards, and agent proximity using a sensor subsystem;
computing a valuation score for each candidate action based on weighted components including:
(a) immediate task utility;
(b) forward-looking opportunity access;
(c) coordination benefit;
(d) environmental richness;
(e) operational cost; and
(f) opportunity cost from survivability risk and foregone alternatives;
selecting the action with the highest valuation score and executing it;
monitoring the agent's valuation score trends and cumulative penalty exposure; and
if all candidate actions fall below a predefined valuation threshold, or if dynamic weighting parameters degrade to unusable levels, activating a fallback policy comprising at least one of:
(a) entering an idle state;
(b) retreating to a designated safe location;
(c) executing a low-risk conservative action; or
(d) escalating control to an external supervisory system;
wherein the method is executed in real time without reliance on global state convergence or offline retraining.
